(19) United States
(12) Patent Application Publication
(10) Pub. No.: US 2013/0164586 A1
(43) Pub. Date: Jun. 27, 2013

(54) STORAGE DEVICE

(71) Applicant: MITSUBISHI HEAVY INDUSTRIES, LTD., Tokyo (JP)

(72) Inventor: Masataka Uchida, Tokyo (JP)

(73) Assignee: MITSUBISHI HEAVY INDUSTRIES, LTD., Tokyo (JP)

(21) Appl. No.: 13/724,317

(22) Filed: Dec. 21, 2012

(30) Foreign Application Priority Data
Dec. 26, 2011 (JP) 2011-283860

(51) Int. Cl. A47F 5/00; H01M 2/10

(52) U.S. Cl. CPC A47F 5/00; H01M 2/1022; H01M 2/1072
USPC 429/96; 211/134

(57) ABSTRACT

A storage device is provided where a stored object may be arranged appropriately on the shelf plate without using a partition member or a locking member and the shelf plate may store the stored object appropriately even though vibration or inclination occurs. A storage device includes a storage shelf having a shelf plate where a concave portion is formed at a predetermined arrangement position, and a stored object arranged at the predetermined arrangement position and having a convex portion which is fitted into the concave portion without being loosened substantially.

### BACKGROUND OF THE INVENTION

1. Field of the Invention

The present invention relates to a storage device and specifically, to a storage device which appropriately stores a stored object at a predetermined arrangement position thereof.

Priority is claimed on Japanese Patent Application No. 2011-283860, filed on Dec. 26, 2011, the content of which is incorporated herein by reference.

2. Description of Related Art

A storage device configured of a storage shelf such as a rack and a cabinet, and a plurality of stored objects which are stored on the storage shelf is used in various fields including household and business.

In addition, in order to align and arrange a stored object on the storage shelf, a technique, in which a partition member is fixed to a shelf plate of the storage shelf (see, Japanese Unexamined Patent Application, First Publication No. H7-257714) or a technique, in which a locking member which can pinch and press a stored object between shelf plates of the storage shelf is fixed (see, Japanese Utility Model Registered Publication No. 3046515) is disclosed.

### SUMMARY OF THE INVENTION

However, in the technique disclosed in Japanese Unexamined Patent Application No. 7-257714 and Japanese Utility Model Registered Publication No. 3046515, since the partition member or the locking member is used, a cost increase in the storage device cannot be avoided.

Meanwhile, in a case where the stored object is arranged on the shelf plate without using the partition member or the locking member, it is difficult to appropriately arrange the stored object at the predetermined arrangement position. In addition, the storage device may be included in a moving body such as a vehicle, a ship and an airplane, and in a case where the stored object is arranged on the shelf plate without using the partition member or the locking member, vibration or inclination is applied to the storage device so that there is concern that the stored object may be damaged by being dropped or the like from the shelf plate.

Thus, an object of the invention is to provide a storage device which may appropriately arrange a stored object on a shelf plate without using the partition member or the locking member described above, and may appropriately store the stored object even though vibration or inclination occurs.

In order to achieve the object described above, a storage device of the invention includes a storage shelf having a shelf plate where a concave portion is formed at a predetermined arrangement position, and a stored object arranged at the predetermined arrangement position and having a convex portion which is fitted into the concave portion without being loosened substantially.

Accordingly, the convex portion of the stored object, which is arranged on the shelf plate, is fitted into the concave portion of the shelf plate so that the stored object may be arranged appropriately at the predetermined arrangement position. Even though vibration or inclination occurs in the storage device, the convex portion of the stored object is fitted and engaged in the concave portion of the shelf plate so that the stored object may be maintained at the predetermined arrangement position.

According to the storage device of the invention, the stored object may be arranged appropriately on the shelf plate without using the partition member or the locking member and the storage device may store the stored object appropriately even though vibration or inclination occurs.

### BRIEF DESCRIPTION OF THE DRAWINGS

FIG. 1 is an outline view of a first embodiment of a storage device of the invention.

FIG. 2A is a plan view of a shelf plate used in the storage device of FIG. 1, FIG. 2B is a front view of a stored object placed on the shelf plate of FIG. 2A and FIG. 2C is a side view of the stored object placed on the shelf plate of FIG. 2A.

FIG. 3A is a plan view of a first modification example of the storage device of FIG. 1 and FIG. 3B is a plan view of a second modification example of the storage device of FIG. 1.

FIG. 4 is a plan view of a third modification example of the storage device of FIG. 1.

FIG. 5A is a plan view of a fourth modification example of the storage device of FIG. 1 and FIG. 5B is a plan view of a fifth modification example of the storage device of FIG. 1.

FIG. 6A is a plan view of a shelf plate used in a second embodiment of the storage device of the invention, FIG. 6B is a front view of the stored object placed on the shelf plate of FIG. 6A and FIG. 6C is a side view of the stored object placed on the shelf plate of FIG. 6A.

### DETAILED DESCRIPTION OF THE INVENTION

In the storage device according to the embodiments of the invention, one of characteristics is that a convex portion, which is provided in the stored object beforehand, is fitted into a concave portion which is provided on the storage shelf beforehand and then the stored object is arranged appropriately on the storage shelf. Hereinafter, description thereof is given with reference to the drawings.

### First Embodiment

The storage device according to the first embodiment of the invention is described with reference to the drawing. In addition, XYZ orthogonal coordinate system illustrated in the drawings is described as identical in all drawing.

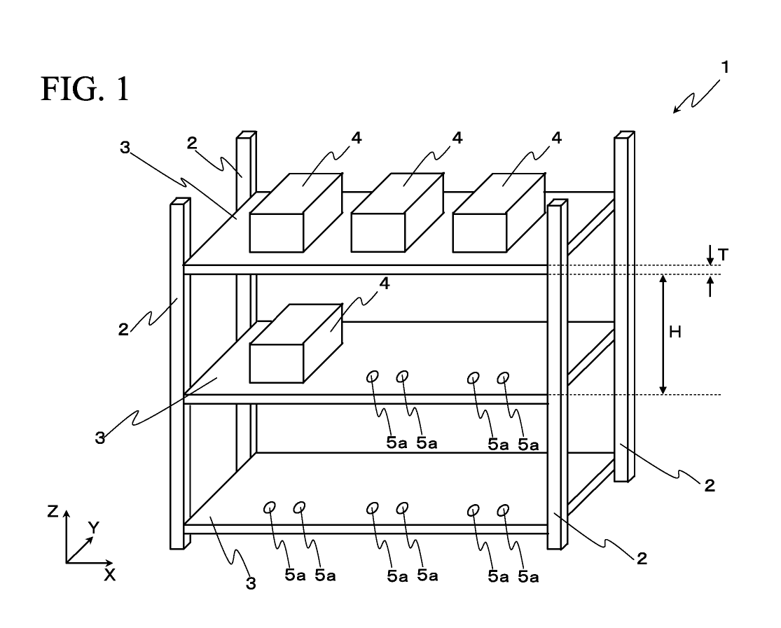

FIG. 1 is a view illustrating a configuration of a storage device 1 including a storage shelf and a plurality of stored objects 4. The storage shelf includes four support posts 2 extending in the Z-direction (in other words, the height direction) and a plurality of shelf plates 3 which is supported by the support posts. Here, each of support posts 2 is arranged at four corners of the substantially rectangular shelf plate 3 and fixed to each other by screwing, welding or the like. Thus, three sheets of the shelf plates 3 are arranged with a gap in the Z-direction therebetween of a height H.

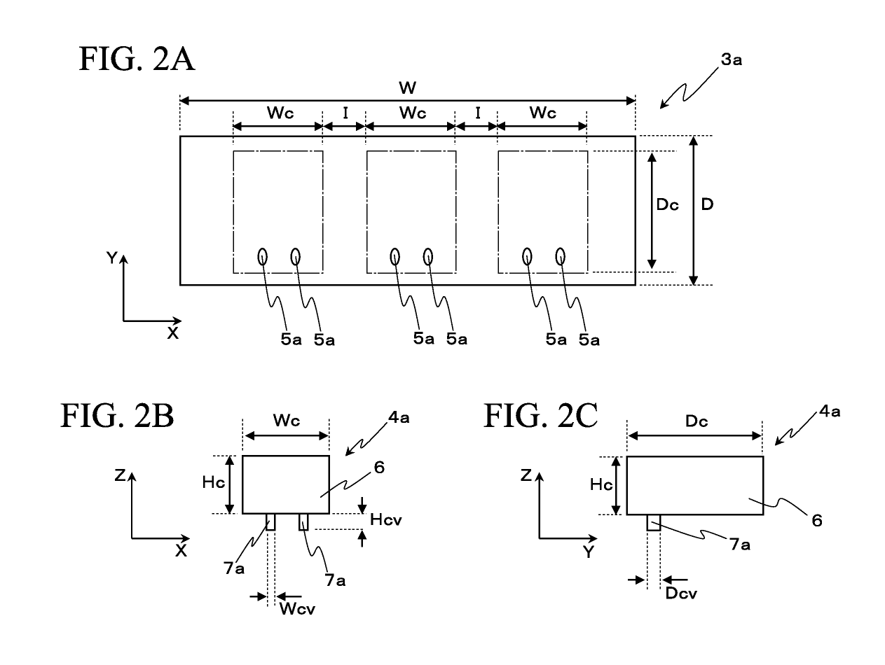

As shown in FIGS. 1 and 2A, one shelf plate 3 is a substantially rectangular plate having a width W in the X-direction (in other words, the width direction), a depth D in the Y-direction (in other words, the depth direction) and a thickness T in the Z-direction. Thus, a stored object 4a as the stored object 4 is arranged at a predetermined arrangement position on a shelf plate 3a as the shelf plate 3. A concave portion 5a corresponding to each of stored objects 4a is formed to the inside of the predetermined arrangement position of the stored object 4a on the shelf plate 3a.

The predetermined arrangement positions are a predetermined positions where the stored objects 4 are loaded or placed on the shelf plate 3 and for the sake of understanding, illustrated by alternate long and short dash lines in FIG. 2A. The alternate long and short dash lines illustrating the predetermined arrangement positions have the same shape as the shape of the stored objects 4 in the XY-plane. Here, three stored objects 4a are arranged having an interval I at regular intervals in the X-direction and then three predetermined arrangement positions are also illustrated.

In addition, the alternate long and short dash lines are merely illustrated only for the sake of understanding, the alternate long and short dash lines are not actually marked on the shelf plate 3. However, in order to easily arrange the stored objects 4 on the shelf plate 3, the marking or the like may be carried out practically using color paint or the like.

Meanwhile, the stored object 4a includes a main body section 6 and a convex portion 7a fixed to the main body section 6. As shown in FIGS. 1, 2B and 2C, the main body section 6 has a substantially rectangular parallelepiped shape having a width Wc in the X-direction, a depth Dc in the Y-direction and a height Hc in the Z-direction. In addition, the convex portion 7a has a width Wcv in the X-direction, a depth Dcv in the Y-direction and a thickness T or a thickness smaller than the thickness T in the Z-direction and then protrudes from the main body section 6. In addition, the entire convex portion 7a has a shape which is fitted into the concave portion 5a without being loosened substantially. In other words, the shapes of the concave portion 5a and the convex portion 7a are similar to each other in the XY-plane.

Here, in order to easily fit the concave portion 5a and the convex portion 7a to each other, the shape of the convex portion 7a in the XY-plane is a shape having no corners. Specifically, the convex portion 7a is an oval shape having a long axis length of Dcv and a short axis length of Wcv. In addition, the shape of the concave portion 5a in the XY-plane is similar to the shape of the convex portion 7a. In addition, the concave portion 5a has substantially the same size as that of the convex portion 7a, and is an oval shape having a long axis and a short axis slightly larger than those of the convex portion 7a.

The stored object 4a has the shape of a container and is configured to further store a predetermined object inside the container. In this case, the convex portion 7a may be integrally formed from the container initially and may be connected to the container with a screw or the like after separately formed from the container.

In addition, the stored object 4a may be the object itself rather than the container. Specifically, a battery pack (in other words, corresponding to the object described above), electrically connecting a plurality of lithium ion secondary batteries may be the stored object 4a by integrally fixing the battery pack using a fixing member configured of frame-like skeleton or the like without looseness. In this case, the fixing member is formed from resin and the convex portion 7a may be integrally formed with the fixing member in a form or the convex portion 7a is prepared separately from the fixing member and then they may be connected to each other by screwing or the like.

In addition, relationship of each length is that 0<3×Wc+2×I<W, 0<Dcv<Dc<D, 0<Hcv≦T, 0<Hc+Hcv<H, 0<Wcv<Wc, 0<I, 0<Hc and 0<Hcv.

As shown in FIGS. 1, 2A to 2C, two convex portions 7a and two concave portions 5a are prepared respectively at positions corresponding to each other on the shelf plate 3 and one stored object 4a arranged thereon. Specifically, it is assumed that a user stands on a −Y side of the shelf plate 3 and the user arranges the stored object 4a on the shelf plate 3 from the position in FIGS. 1, 2A to 2C so that two concave portions 5a corresponding to one stored object 4a are formed further to the −Y side than an imaginary line drawn in the X-direction from the midpoint of the depth D of the shelf plate 3 in the Y-direction. Since the concave portion 5a is formed at a position which is closer to the standing position of the user, the user easily fits the convex portions 7a of the stored object 4a into the corresponding concave portions 5a and the storage may be performed more quickly.

In addition, since two convex portions 7a of one stored object 4a are fitted into two corresponding concave portions 5a without looseness substantially, the stored object 4a may be arranged appropriately on the designed predetermined arrangement position, and a positional shift thereof due to vibration or the like and specifically, the rotation of the stored object 4a in the XY-plane may be prevented.

In order to prevent the rotation of the stored object 4a due to the vibration or the like, at least two convex portions 7a are arranged on one stored object 4a and at least two corresponding concave portions 5a may be formed on the shelf plate 3 inwards the predetermined arrangement positions of the stored object 4a. In other words, from this viewpoint, the shape of the concave portion 5a and the convex portion 7a may not necessarily be an oval, and may be circular or polygonal (for example, triangular or square).

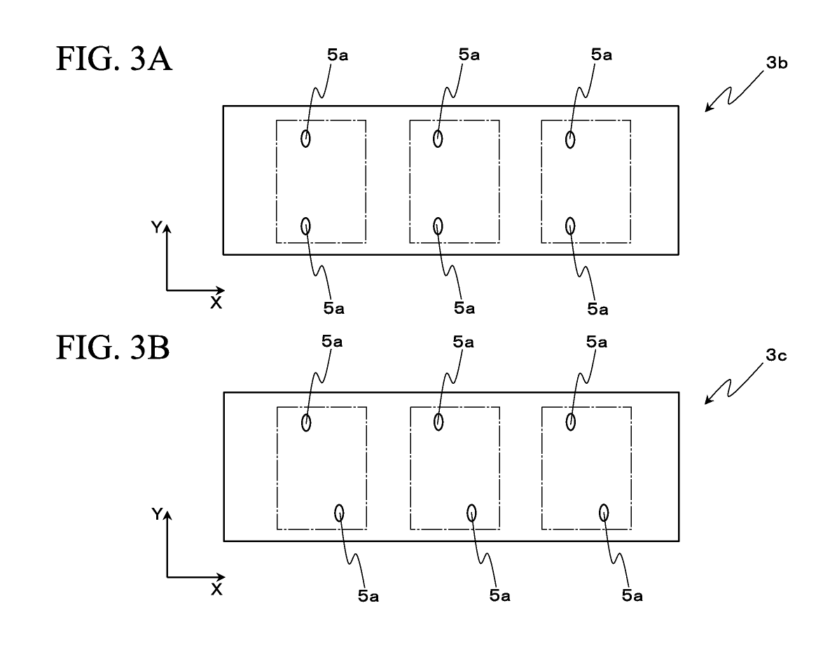

Accordingly, as a first modification example illustrated in FIG. 3A, in the storage device 1, a shelf plate 3b, where two concave portions 5a corresponding to one stored object 4 are formed further to the −X side than an imaginary line drawn in the Y-direction from the midpoint of the width Wc of the X-direction at the predetermined arrangement position of the stored object 4, may be employed instead of the shelf plate 3a. In this case, two convex portions 7a, which are fitted simultaneously into two concave portions 5a without looseness substantially, are arranged respectively on the stored object 4. In the first modification example, two concave portions 5a are formed further to the −X side than an imaginary line drawn in the Y-direction from the midpoint of the width Wc of the X-direction at the predetermined arrangement position of the stored objects 4, however, two concave portions 5a may be formed on the +X side.

In addition, as a second modification example illustrated in FIG. 3B, in the storage device 1, a shelf plate 3c, where two concave portions 5a corresponding to one stored object 4 are formed on a diagonal line inwards the predetermined arrangement position on the stored object 4, may be employed instead of the shelf plate 3a. In this case, two convex portions 7a, which are fitted simultaneously into two concave portions 5a without looseness substantially, are respectively arranged on the stored object 4.

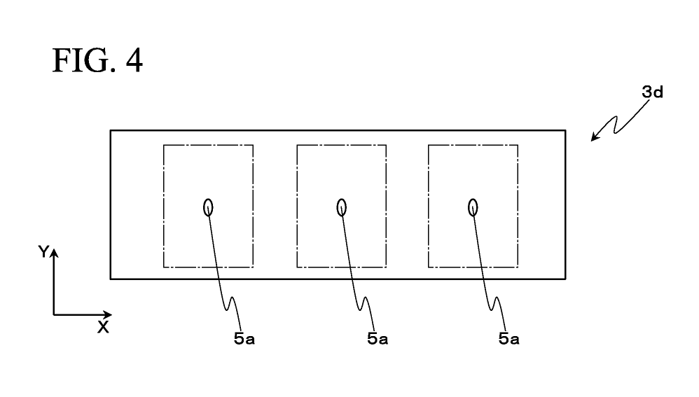

In addition, when the shape of the concave portion 5a and the convex portion 7a in the XY-plane is an oval, the rotation described above may be prevented even in the configuration where a plurality of convex portions 7a is not arranged on one stored object 4 but only one convex portion 7a is arranged on one stored object 4. Accordingly, as a third modification example illustrated in FIG. 4, in the storage device 1, a shelf plate 3d, where one concave portion 5a corresponding to one stored object 4 is formed at a position corresponding to the center of gravity of the stored object 4 inwards of the predetermined arrangement position on the stored object 4, may be employed instead of the shelf plate 3a. In this case, only one convex portion 7a, which is fitted into only one concave portion 5a without looseness substantially, is arranged on the stored object 4.

Since the storage device of the third modification example has the number of the convex portions 7a and the concave portions 5a corresponding to one stored object 4 fewer than that of the first embodiment of the storage device, and the first and the second modification examples thereof, the cost of the storage device may be deduced.

However, in the first embodiment and the modification examples thereof described above, for example, when the stored object 4 is temporarily placed on the ground or the like before the stored object 4 is arranged on the shelf plate 3, the main body section 6 is likely to be temporarily placed in an state inclined from the XY-plane. If it is not desirable that the main body section 6 be arranged in an inclined state due to the nature of the object described above, three or more convex portions 7a, which are arranged on the stored object 4, are arranged appropriately so that arrangement in the inclined state may be avoided.

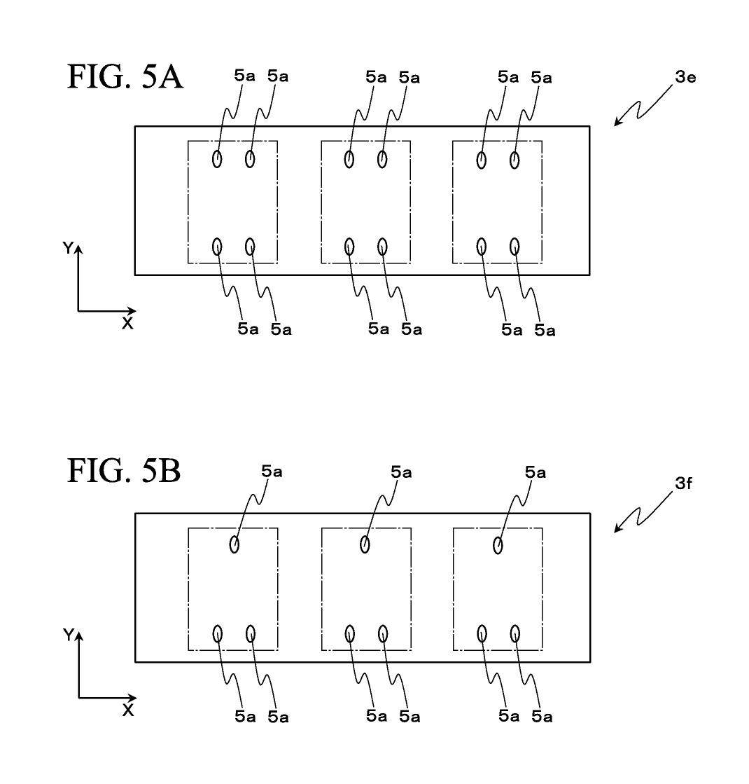

Accordingly, as a fourth modification example illustrated in FIG. 5A, in the storage device 1, a shelf plate 3e, where four concave portions 5a corresponding to one stored object 4 are formed respectively near four corners of the predetermined arrangement position on the stored object 4, may be employed instead of the shelf plate 3a. In this case, four convex portions 7a, which are fitted simultaneously into four concave portions 5a without being loosened substantially, are arranged respectively on the stored objects 4.

In addition, as a fifth modification example illustrated in FIG. 5B, in the storage device 1, a shelf plate 3f, where three concave portions 5a corresponding to one stored object 4 are formed by spreading out from each other by a predetermined distance from a position corresponding to the center of gravity of the stored objects 4 and at the predetermined arrangement positions on the stored object 4, may be employed instead of the shelf plate 3a. In this case, three convex portions 7a, which are fitted simultaneously into three concave portions 5a without looseness, are arranged on the stored object 4 respectively.

According to the first embodiment of the storage device and modification examples thereof, the stored object 4 may be appropriately arranged at a predetermined position and a plurality of stored objects 4 may be aligned and easily arranged with respect to each other at a predetermined position without using the partition member or the locking member disclosed in Japanese Unexamined Patent Application No. 7-257714 and Japanese Utility Model Registered Publication No. 3046515. Furthermore, the alignment of the stored object 4 can be prevented from being disturbed by the rotation or the like due to the vibration or the like. In addition, the stored objects 4 can be prevented from dropping or the like even due to the vibration or the like.

Accordingly, the storage device having low cost and high safety may be provided.

### Second Embodiment

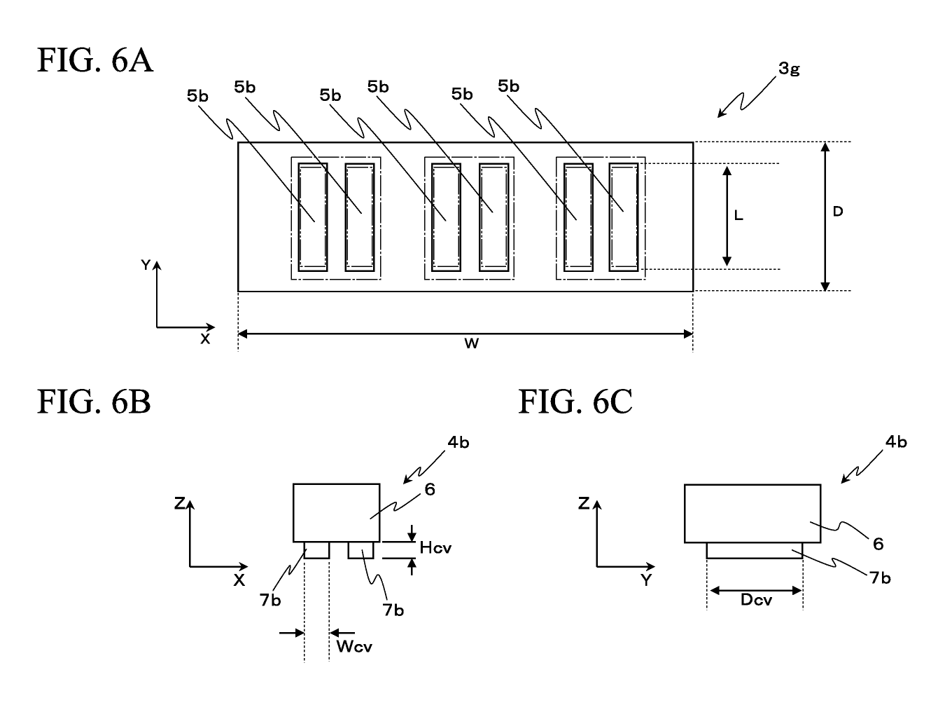

A second embodiment of the storage device of the invention is described with reference to FIGS. 6A to 6C. In addition, points which differ from the first embodiment are that as the shelf plate 3, a shelf plate 3g is used instead of the shelf plate 3a and as the stored object 4, a stored object 4b is used instead of the stored object 4a. Thus, the same reference numerals are added to the same configurations of the first embodiment and the descriptions thereof are omitted.

In the first embodiment of the storage device and the modification examples thereof, the concave portion 5 formed on the shelf plate 3 is the concave portion 5a having an oval shape as the shape in the XY-plane. As shown in FIG. 6A, a substantially rectangular concave portion 5b is formed on a shelf plate 3g which is used in the second embodiment. As shown in FIGS. 6B and 6C, similar to the convex portion 7a, two convex portions 7b are fixed on the main body section 6 of the stored object 4b. The convex portion 7b has a width Wcv in the X-direction, a depth Dcv in the Y-direction and a thickness T or a thickness smaller than the thickness T in the Z-direction and protruding from the main body section 6. In addition, the entire convex portion 7b has a shape which is fitted into the concave portion 5b without looseness substantially. In other words, the shapes of the concave portion 5b and the convex portion 7b are similar to each other in the XY-plane. Accordingly, the shape of the concave portion 5b in the XY-plane is similar to the shape of the convex portion 7b and has substantially the same size as that of the convex portion 7b, and has sizes which are slightly larger than those of the convex portion 7b. For the sake of understanding, the convex portion 7b, which is fitted into the concave portion 5b, is illustrated by alternate long and two short dash lines in FIG. 6A.

Two larger convex portions 7b having the depth Dcv, in the Y-direction (Dc/2), is formed on the main body section 6 across the center of gravity of the main body section 6. As a result, the stored object 4 like “a sled” is formed so that the stored object 4 is can be prevent from rotating or detaching effectively compared to the first embodiment of the storage device and the modification examples thereof. In addition, even when the stored objects 4 are temporarily placed, the main body section 6 may be placed parallel to the XY-plane.

According to the second embodiment of the storage device described above, similar to the first embodiment of the storage device, the storage device having low cost and high safety may be provided.

In addition, characteristics of the first embodiment, modification examples and the second embodiment of the storage device are fused together appropriately and then the storage device may be formed. In addition, here, the example of three-stage storage shelf formed of three sheets of the shelf plates is illustrated, however, it may be a storage shelf with additional stages. The storage device may be configured of different shelf plates and composition of the stored objects corresponding thereto for each stage of the storage shelf.

The support post 2, the shelf plate 3 and the convex portion 7 described above may be formed of plastic resin or metal. In a case where the object described above is electrical appliance such as the lithium secondary battery, when the object is formed, for example, of reinforced plastic, electric leakage may be avoided so that the safety of the storage device can be further enhanced. In addition, a total of four support posts 2 configuring the storage shelf are used, however, the storage shelf, in which the shelf plate 3 is supported by two side plates instead of the support posts 2, may be provided because the side plates may support the shelf plate 3.

The invention is not limited to the embodiments and modification examples thereof described above, various modifications are possible without departing from the gist of the invention. For example, the concave portion 5 formed on the shelf plate 3 may be a through hole passing through a front and back surfaces of the shelf plate 3. In addition, the shapes of the shelf plate 3 or the stored object 4 are not limited to the shapes described above, and may be various shapes such as circular and polygonal without departing from the gist of the invention.

Furthermore, the number of stored objects 4 arranged on the shelf plate 3 is not limited to three and may be set to more than or less than three according to the design thereof.

While preferred embodiments of the invention have been described and illustrated above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A storage device comprising:
a storage shelf having a shelf plate where a concave portion is formed at a predetermined arrangement position; and
a stored object arranged at the predetermined arrangement position and having a convex portion which is fitted into the concave portion without being loosened substantially.

2. The storage device according to claim 1,
wherein the shelf plate has a plurality of the predetermined arrangement positions and the stored objects are aligned and arranged respectively at the plurality of predetermined arrangement positions.

3. The storage device according to claim 2,
wherein the convex portion is substantially a rectangular or oval shape and the concave portion has a shape similar to the convex portion.

4. The storage device according to claim 3,
wherein the concave portion is a through hole which passes through a front and back surfaces of the shelf plate.

5. The storage device according to claim 4,
wherein the stored object is a battery system with a fixing portion that fixes the battery system, and
the convex portion is formed on the fixing portion.
